(19) United States
(12) Patent Application Publication
(10) Pub. No.: US 2006/0118704 A1
(43) Pub. Date: Jun. 8, 2006

(54) Optical pickup device and optical element

(75) Inventor: Tomohiro Shimoguchi, Kawaguchi-shi (JP)

Correspondence Address: KODA & ANDROLIA, 2029 CENTURY PARK EAST, SUITE 1140, LOS ANGELES, CA, 90067, US

(73) Assignee: Enplas Corporation

(21) Appl. No.: 11/285,100

(22) Filed: Nov. 21, 2005

(30) Foreign Application Priority Data
Nov. 26, 2004 (JP) 2004-341785

(51) Int. Cl. H01J 3/14; H01J 40/14

(52) U.S. Cl. 250/216

(57) ABSTRACT

It is to provide an optical pickup device and an optical element, which can appropriately perform signal processing for a plurality of sets of light having different wavelength from each other by a single light receiving element, can cut the cost, and can widen versatility of possible design form. There are provided: a first and a second light sources for emitting first light and second light having different wavelengths; an optical information recording medium; an objective lens for concentrating a first and/or second light; an optical element which comprises an astigmatism generating structure for giving astigmatism to the first and second light, and a diffraction structure for diffracting at least either the first or the second light; and a light receiving element.

### BACKGROUND OF THE INVENTION

1. Field of the Invention

The present invention relates to an optical pickup device and an optical element and, more specifically, to an optical pickup device and an optical element, which are suitable for adjusting the light quantity at the time of transmitting the light from an incident side towards an emission side.

2. Description of the Related Art

As an optical pickup device for performing reproduction and recording from/to an optical disk such as a CD or a DVD, in general, used for the DVD that uses light with a wavelength of about 657 nm is an optical pickup device of a polarization optical system which comprises a polarizing element such as a polarizing beam splitter, and used for the CD that uses light with a wavelength of about 780 nm is an optical pickup device of a non-polarization optical system which does not comprises a polarizing beam splitter.

In the optical pickup device of the polarization optical system, for example, light emitted from a light source can be reflected towards an optical disk side with high reflectance by a polarizing beam splitter. After being reflected to the optical disk side, the light that is retuned to the polarizing beam splitter by being reflected upon making incidence to a recording face of the optical disk can be transmitted to a light receiving element (photodetector (PD) or the like) side with high transmittance by the polarizing beam splitter.

Therefore, the optical pickup device of the polarization optical system has high use-efficiency of light and the quantity of light that makes incidence to the light receiving element is relatively large.

Meanwhile, in the optical pickup device of the non-polarization system, light emitted from a light source is reflected to the optical disk side by a wave-selecting beam splitter, for example, but not by the polarizing beam splitter. Then, after being reflected to the optical disk side, the light that is retuned to the wave-selecting beam splitter by being reflected upon making incidence to a recording face of the optical disk is transmitted to a light receiving element side by the wave-selecting beam splitter.

However, in that case, the reflectance of the light reflected by the wave-selecting beam splitter towards the optical disk side and the transmittance of the light transmitted towards the light receiving element side are lower, respectively, with respect to the case of the polarizing beam splitter.

Therefore, the optical pickup device of the non-polarization optical system has low use-efficiency of light and the quantity of light that makes incidence to the light receiving element becomes small.

Thus, in the optical pickup device of the non-polarization optical system, light-receiving signals are often processed by increasing the S/N ratio for improving the use-efficiency and increasing the gain. In the meantime, in the optical pickup device of the polarization optical system, signal processing cannot be performed appropriately since the increased gain is rather saturated.

Therefore, in order to appropriately perform signal processing of both the polarization system and the non-polarization system using a single light receiving element, it requires to align the light quantity received by the light receiving element between the wavelength of light used for the polarization optical system and the wavelength of light used for the non-polarization optical system. For that, there is required an element for adjusting the light quantity to a preferable value in accordance with the wavelength.

Thus, as a method for adjusting the light quantity, there has been disclosed a method for forming a light absorption film on a surface of an optical system (for example, see Patent Document 1).

Patent Document 1: Japanese Patent Unexamined Publication 2004-128065

However, when the light quantity is adjusted by using the light absorption film, there generates heat in accordance with absorption of light so that there may cause a temperature increase of 20-30° C.

Due to such temperature increase, the property of the light absorption film is deteriorated so that the light quantity cannot be adjusted. As a result, signal processing for both the polarization optical system and the non-polarization optical system cannot be performed appropriately by a single light receiving element. In other words, it causes a problem that light signals of a plurality of different wavelengths cannot be received and processed appropriately.

Further, it is necessary to form the light absorption film by coating, thereby causing an increase of the cost.

Furthermore, in the case where a lens face 31 and a holder 32 are integrated as in an optical element 30 of FIG. 7, coating of the light absorption film cannot be performed appropriately on the lens face 31 if depth t of the lens face 31 from the end face of the holder 32 is extremely deep.

Therefore, for designing it without having such problems, it is necessary to restrict the shape of the product so that coating of the light absorption film can be easily performed. As a result, it narrows the versatility of possible design form.

### SUMMARY OF THE INVENTION

The present invention has been designed in view of the aforementioned problems. An object of the present invention therefore is to provide an optical pickup device and an optical element, which can maintain an excellent optical property for a long time without generating heat, so that all the processing for plurality of light signals with different wavelengths from each other can be performed appropriately by a single light receiving element, the cost can be cut, and the versatility of the possible design form can be widened.

In order to achieve the aforementioned object, an optical pickup device according to a first aspect of the present invention comprises: a first light source for emitting first light which is coherent light having a first wavelength; a second light source for emitting second light which is coherent light having a second wavelength that is different from the first wavelength; an optical information recording medium; an objective lens for concentrating the first light and/or the second light on the optical information recording medium; an optical element which has an astigmatism generating structure for giving astigmatism to the first light and the second light, and also has a diffraction structure for diffracting at least either the first light or the second light; and a light receiving element for receiving light which is reflected from the optical information recording medium.

In the first aspect of the present invention, there is provided the optical element of a simple structure which comprises the astigmatism generating structure and the diffraction structure that has appropriate diffraction efficiencies in accordance with the wavelength and light quantity of the incident light. Thereby, it enables to adjust at least either the first light or the second light, which is emitted from the optical element towards the light receiving element, to be the preferable light quantity for being sensed by the light receiving element.

Adjustment herein means to adjust, through diffraction by the diffraction structure, the quantity of light that is emitted from the optical element and travels towards the light receiving element to be the preferable quantity for being sensed by the light receiving element, and it does not include the case where the quantity of the light emitted from the optical element and travels toward the light receiving element, without being diffracted by the diffraction structure, is already the preferable light quantity for being sensed by the light receiving element (it is the same in the followings).

Therefore, for example, if either the first light or the second light without being diffracted by the diffraction structure has the preferable quantity for being sensed by the light receiving element at the point of being emitted from the optical element and traveling towards the light receiving element, light quantities of both light can be made the preferable light quantity for being sensed by the light receiving element by adjusting only the light quantity of the other light.

Further, the optical pickup device according to a second aspect of the present invention is the optical pickup device of the first aspect, wherein both of the first light and the second light are diffracted by the diffraction structure of the optical element.

With the second aspect of the present invention, further, it is possible through the optical element to adjust the light quantities of both the first light and the second light, which are emitted from the optical element towards the light receiving element, to be the preferable light quantity for being sensed by the light receiving element.

Further, the optical pickup device according to a third aspect of the present invention is the optical pickup device of the first or the second aspect, wherein light quantity of the first light that is emitted from the optical element and travels towards the light receiving element and light quantity of the second light that is emitted from the optical element and travels towards the light receiving element are adjusted to be identical.

With the third aspect of the present invention, further, it is possible through the optical element to adjust the light quantities of both the first light and the second light, which are emitted from the optical element towards the light receiving element, to be the preferable light quantity for being sensed by the light receiving element.

Furthermore, the optical pickup device according to a fourth aspect comprises: at least three light sources of a first light source for emitting first light which is coherent light having a first wavelength, a second light source for emitting second light which is coherent light having a second wavelength that is different from the first wavelength, and a third light source for emitting third light which is coherent light having a third wavelength that is different from the first wavelength and the second wavelength; an optical information recording medium; an objective lens for concentrating, on the optical information recording medium, at least a single set of light among the first light, the second light, and the third light; an optical element which has an astigmatism generating structure for giving astigmatism to the first light, the second light, and the third light, and also has a diffraction structure for diffracting at least a single set of light among the first light, the second light, and the third light; and a light receiving element for receiving light which is reflected from the optical information recording medium.

With the fourth aspect of the present invention, through the optical element of a simple structure which has the astigmatism generating structure and the diffraction structure with appropriate diffraction efficiencies in accordance with the wavelength and the light quantity of the incident light, it enables to adjust the light quantity of at least a single set of light among the first light, the second light, and the third light, which are emitted from the optical element and travel towards the light receiving element.

Further, the optical pickup device according to a fifth aspect is the optical pickup device of any one of the first to fourth aspects, wherein the optical element is disposed on an optical path between the objective lens and the light receiving element.

Furthermore, with the fifth aspect of the present invention, it enables to dispose the optical element at a preferable position for effectively utilizing the light that is emitted from the light source.

The optical element according to a sixth aspect receives coherent light that is selected from at least two or more sets of coherent light having different wavelength from each other. The optical element comprises an astigmatism generating structure for giving astigmatism to at least the two or more sets of coherent light having different wavelength from each other, and also has a diffraction structure for diffracting at least a single wavelength of light out of at least the two or more sets of coherent light having different wavelength from each other, wherein through diffraction by the diffraction structure, light quantity on the optical axis of at least the single wavelength of light can be adjusted.

With the sixth aspect of the present invention, through the optical element of a simple structure which has the astigmatism generating structure and the diffraction structure with appropriate diffraction efficiencies in accordance with the wavelength and the light quantity of the incident light, it enables to adjust the light quantity on the optical axis of at least a single wavelength of light that is emitted form the optical element.

Furthermore, the optical element according to a seventh aspect is the optical element of the sixth aspect, wherein, through diffracting at least the two or more wavelengths of light by the diffraction structure out of at least the two or more sets of coherent light having different wavelength from each other, light quantities on optical axis of at least the two or more wavelengths of light can be adjusted.

With the seventh aspect of the present invention, further, it is possible to adjust the light quantities on the optical axis of at least the two or more wavelengths of light emitted from the optical element to be the preferable light quantity for being sensed by the light receiving element that is positioned on the optical axis.

The optical element according to an eighth aspect of the present invention is the optical element of the sixth or seventh aspect, wherein the light quantities on the optical axis of at least the two or more sets of coherent light having different wavelength from each other, which are emitted from the optical element, become identical.

With the eighth aspect of the present invention, further, it is possible to adjust at least the two or more sets of coherent light having different wavelength from each other, which are emitted from the optical element, to be more preferable for being sensed by the light receiving element that is positioned on the optical axis.

At least the two or more sets of coherent light with different wavelength, which are emitted from the optical element of the eighth aspect, may include only the light whose light quantity on the optical axis is diffracted by the diffraction structure or, in addition, it may include light whose light quantity when emitted from the optical element without being diffracted by the diffraction structure has the preferable quantity for being sensed by the light receiving element.

In the pickup device according to the first aspect of the present invention, there is provided the optical element of a simple structure which comprises the astigmatism generating structure and the diffraction structure that has appropriate diffraction efficiencies in accordance with the wavelength and light quantity of the incident light. Thereby, it enables to adjust at least either the first light or the second light, which is emitted from the optical element towards the light receiving element, to be the preferable light quantity for being sensed by the light receiving element. As a result, the excellent optical property can be maintained for a long time without generating heat. Therefore, signal processing for a plurality of sets of light with different wavelength from each other can all be performed appropriately by a single light receiving element. In addition, it enables to achieve the optical pickup device which can cut the cost and widen the versatility of the possible design form.

With the second aspect of the present invention, further, it is possible through the optical element to adjust the light quantities of both the first light and the second light, which are emitted from the optical element towards the light receiving element, to be the preferable light quantity for being sensed by the light receiving element. As a result, in addition to the effect of the optical pickup device according to the first aspect, it is possible to achieve the optical pickup device which can more appropriately perform signal processing for a plurality of sets of light having different wavelength from each other.

With the third aspect of the present invention, further, it is possible through the optical element to adjust the light quantities of both the first light and the second light, which are emitted from the optical element towards the light receiving element, to be the preferable light quantity for being sensed by the light receiving element. As a result, in addition to the effect of the optical pickup device according to the first aspect, it is possible to achieve the optical pickup device which can more appropriately perform signal processing for a plurality of sets of light having different wavelength from each other.

Furthermore, with the fourth aspect of the present invention, through the optical element of a simple structure which has the astigmatism generating structure and the diffraction structure with appropriate diffraction efficiencies in accordance with the wavelength and the light quantity of the incident light, it is possible to adjust the light quantity of at least a single set of light among the first light, the second light, and the third light, which are emitted from the optical element and travel towards the light receiving element. As a result, the excellent optical property can be maintained for a long time without generating heat. Therefore, signal processing for three kinds or more of light with different wavelength from each other can all be performed appropriately by a single light receiving element. In addition, it enables to achieve the optical pickup device which enables to cut the cost and widen the versatility of the possible design form.

Further, with the optical pickup device according to the fifth aspect, it enables to dispose the optical element at a preferable position for effectively utilizing the light that is emitted from the light source. As a result, in addition to the effects of the optical pickup device according to the first to fourth aspects, it is possible to achieve the optical pickup device which can effectively utilize the light emitted from the light source.

Furthermore, with the sixth aspect of the present invention, through the optical element of a simple structure which has the astigmatism generating structure and the diffraction structure with appropriate diffraction efficiencies in accordance with the wavelength and the light quantity of the incident light, it is possible to adjust the light quantity on the optical axis of at least a single wavelength of light that is emitted form the optical element. As a result, the excellent optical property can be maintained for a long time without generating heat. Therefore, signal processing for a plurality of sets of light having different wavelength from each other can all be performed appropriately by a single light receiving element. In addition, it enables to achieve the optical pickup device which enables to cut the cost and widen the versatility of the possible design form.

Moreover, it is possible to adjust the light quantities on the optical axis of at least the two or more wavelengths of light emitted from the optical element to be the preferable light quantity for being sensed by the light receiving element that is positioned on the optical axis. As a result, in addition to the effect of the optical pickup device according to the sixth aspect, it is possible to achieve the optical pickup device which can more appropriately perform signal processing for a plurality of sets of light having different wavelength from each other by a single light receiving element.

Further, with the eighth aspect of the present invention, it is possible to adjust the light quantities of at least the two or more sets of coherent light having different wavelength from each other, which are emitted from the optical element, to be more preferable for being sensed by the light receiving element that is positioned on the optical axis. As a result, in addition to the effect of the optical pickup device according to the sixth or seventh aspect, it is possible to achieve the optical pickup device which can more appropriately perform signal processing for a plurality of sets of light having different wavelength from each other by a single light receiving element.

### BRIEF DESCRIPTION OF THE DRAWINGS

FIG. 1 is a longitudinal section for schematically showing an embodiment of an optical element according to the present invention;

FIG. 2 is an illustration for describing the quantity of light for DVD according to the embodiment of the optical element of the present invention;

FIG. 3 is an illustration for describing the quantity of light for CD according to the embodiment of the optical element of the present invention;

FIG. 4 is a longitudinal section for showing another example of diffraction grating according to the embodiment of the optical element of the present invention, which is different from the diffraction grating of FIG. 1;

FIG. 5 is a longitudinal section for showing still another example of diffraction grating according to the embodiment of the optical element of the present invention, which is different from the diffraction gratings of FIG. 1 and FIG. 4;

FIG. 6 is a block diagram for showing an embodiment of an optical pickup device according to the present invention; and

FIG. 7 is a longitudinal section for schematically showing an example of conventional optical element.

### DESCRIPTION OF THE PREFERRED EMBODIMENTS

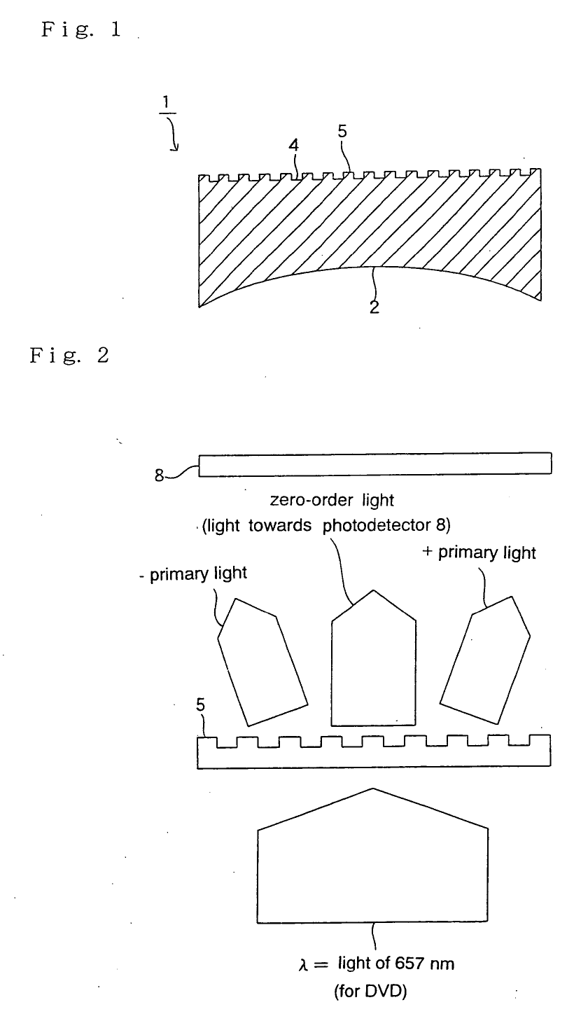

An embodiment of an optical element according to the present invention will be described hereinafter by referring to FIG. 1-FIG. 6.

As shown in FIG. 1, an optical element 1 of this embodiment comprises, on a surface 2 that is on the light incident side, a toric plane as an astigmatism generating structure which gives astigmatism to the incident light.

Diffraction grating 5 as a diffraction structure is formed integrally on the opposite surface of the toric plane of the optical element 1, i.e. on a surface 4 that is on the light-emission side.

The diffraction grating 5 diffracts both the first light that is coherent light with the first wavelength and the second light that is coherent light with the second wavelength, both of which selectively make incidence to the optical element 1 from the toric plane and exit from the surface 4 by transmitting through the optical element 1. Thereby, the light quantity on the optical axis of the first light and the second light emitted from the emission-side surface 4 can be adjusted to be the preferable quantity for being sensed by a light receiving element that is disposed on the optical axis.

Specifically, the diffraction grating 5 has prescribed diffraction efficiencies corresponding to each of the first and second light. Thus, even in the case where the light of 647 nm wavelength as the first light for a DVD 10 serving as an optical disk and the light of 780 nm wavelength as the second light for a CD 21 serving as an optical disk have different light quantity from each other at the time of making incidence to the toric plane, the light quantities of zero-order light as the light quantities on the optical axis of both light can be made the same light quantity that is preferable for being sensed by the light receiving element.

In this manner, the zero-order light that is the light of 657 nm wavelength for the DVD 10 and the zero-order light that is the light of 780 nm wavelength for the CD 21, which are diffracted by the diffraction grating 5, are received by a photodetector 8 as the light receiving element, respectively, and used for reproduction or recording.

The light whose light quantity can be adjusted through diffraction by the diffraction grating 5 is not necessarily limited to the two sets of light such as the first and second light. The light may be a single set of light of a specific wavelength such as either the first light or the second light, or may be three or more sets of coherent light having different wavelength from each other.

Further, as shown in FIG. 2, the diffraction grating 5 diffracts the light of 657 nm wavelength for the DVD 10 in such a manner that the light quantity of the zero-order light becomes 58% with respect to the light quantity at the time of making incidence to the optical element 1.

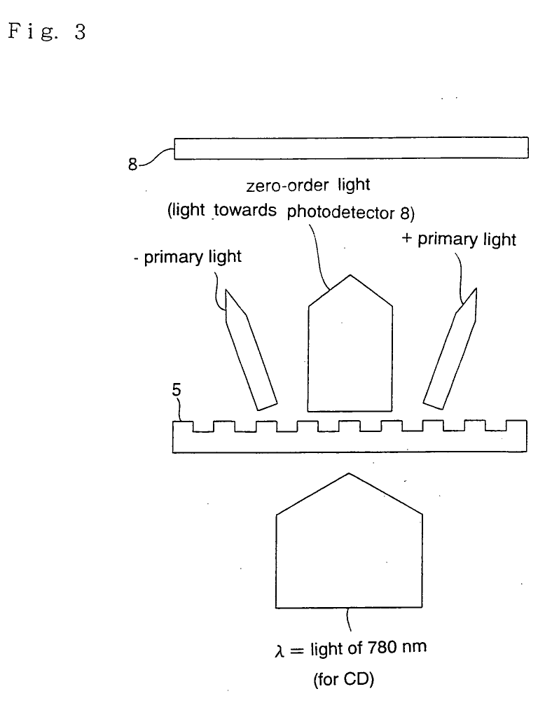

Furthermore, as shown in FIG. 3, the diffraction grating 5 diffracts the light of 657 nm wavelength for the CD 21 in such a manner that the light quantity of the zero-order light becomes 83% with respect to the light quantity at the time of making incidence to the optical element 1.

Therefore, with the embodiment, it is possible to adjust the light quantity of the zero-order light emitted from the emission-side surface 4 of the optical element 1 to be the preferable light quantity for being sensed by the photodetector 8 by a simple structure through diffracting the light by the diffraction grating 5 that is integrally formed with the optical element 1.

As described, when the light quantity of the zero-order light emitted from the emission-side surface 4 is adjusted by utilizing the diffraction grating 5, no heat is generated unlike the case of using the light absorption film. Thus, an excellent optical property can be maintained for a long time and no coating is required. Therefore, it is advantageous in respect that the cost is low, and the versatility of possible design form for the optical element 1 can be widened.

Further, in the embodiment, through diffraction by using the diffraction grating 5, the light quantity of the zero-order light having 657 nm wavelength for the DVD 10 and the light quantity of the zero-order light having 780 nm wavelength for the CD 21, which are emitted from the emission-side surface 4 of the optical element 1, can be made the same light quantity. Therefore, the light quantity of each zero-order light can be made preferable for being sensed by the photodetector 8.

The diffraction grating 5 is not necessarily limited to be formed on the emission-side surface 4 of the optical element 1. For example, it may be formed only on the incident-side surface 2 or on both surfaces 2 and 4 on the incident and emission sides.

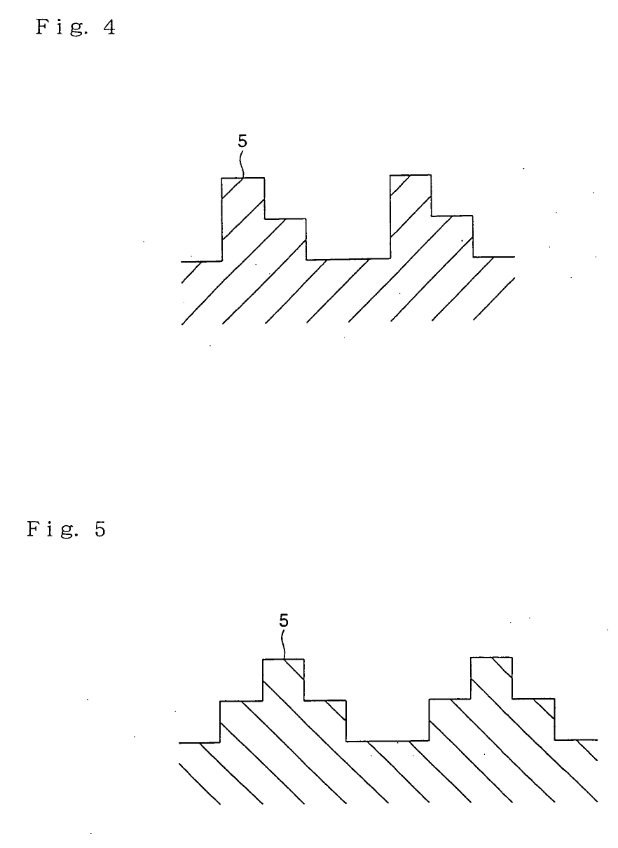

Further, the diffraction grating 5 in FIG. 1 is in a two-step structure when the surface of the optical element 1 is considered as the first step. However, it is not limited to this but may have a three-step structure as shown in FIG. 4 and FIG. 5 or may have a structure with more steps.

Furthermore, examples of an optical material for forming the optical element 1 may be cychroolefin polymer and the like such as ZEONEX (product of ZEON CORPORATION).

Moreover, as the optical material for the optical element 1, it is more preferable to use a material in which the refraction index for the light of 657 nm wavelength is 1.5218, the diffraction index for the light of 780 nm wavelength is 1.5184, the abbe number is 56, and the transmittance of light rays is 92.

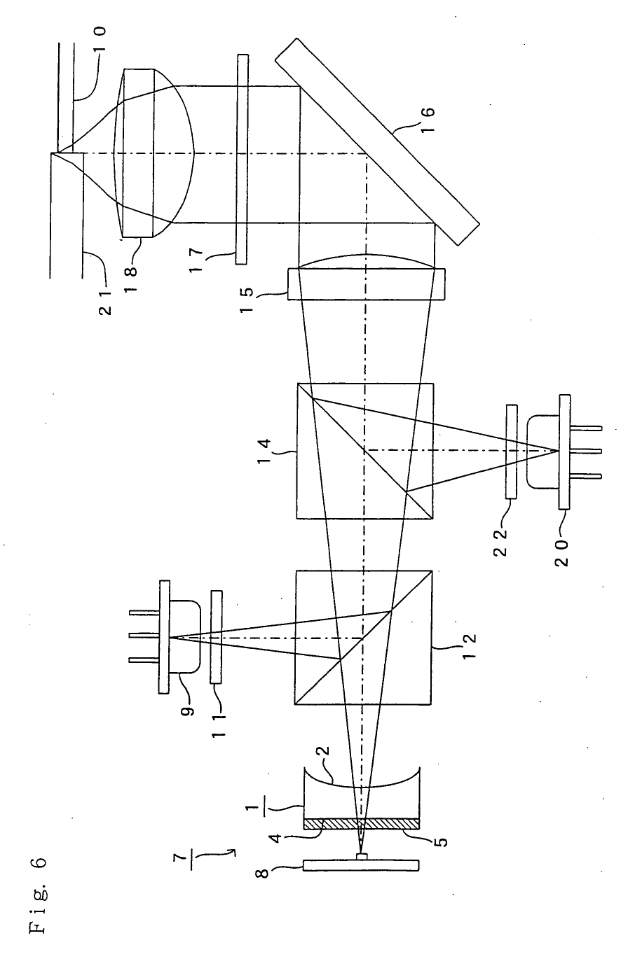

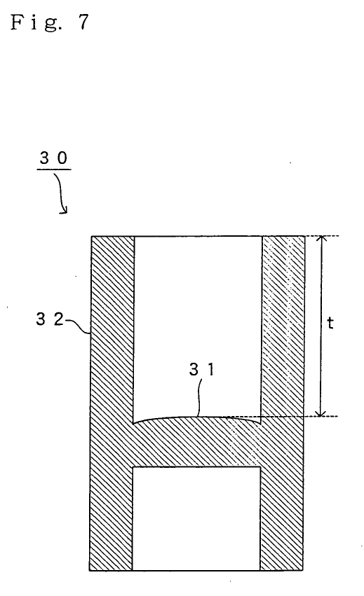

Next, there is described an embodiment of an optical pickup device 7 which uses the optical element 1 of the present invention by referring to FIG. 6.

The optical element 1 structured as described above constitutes the optical pickup device 7 of this embodiment together with other optical systems as shown in FIG. 6.

Specifically, the photodetector 8 is disposed at a position on the light emission side of the optical element 1, and the photodetector 8 receives the zero-order light from the diffraction grating 5.

In the meantime, on the light incident side of the optical element 1, there is disposed an optical system which comprises both a polarization optical system and a non-polarization optical system.

Specifically, the optical pickup device 7 comprises a DVD light source (laser diode) 9 as a first light source for emitting first light that is coherent light having a first wavelength. This DVD light source 9 emits, as linearly polarized light, the light of 657 nm wavelength as the first light for recording information on the DVD 10 in a direction orthogonal to the traveling direction of the light that makes incidence to the optical element 1.

At a position on the light emission side of the DVD light source 9, a DVD-side three-beam generating diffraction grating 11 is disposed. The light emitted from the DVD light source 9 makes incidence to the DVD-side three-beam generating diffraction rating 11.

The DVD-side three-beam generating diffraction grating 11, for tracking, emits the light that makes incidence from the DVD light source 9 after separating it into three beams (referred to as DVD outward three beams hereinafter) of the zero-order light (referred to as the main beam hereinafter) and ±primary light (referred to as the sub-beams hereinafter).

A polarizing beam splitter 12 having a main function as the polarization optical system is disposed at a position on the emission side of the DVD outward three beams with respect to the DVD-side three-beam generating diffraction grating 11, which is a position on the emission side of the DVD outward three beams of the optical element 1 to be described later.

The DVD outward three beams emitted from the DVD-side three-beam generating diffraction grating 11 make incidence to the polarization beam splitter 12.

The polarizing beam splitter 12 reflects the DVD outward three beams which make incidence from the DVD-side three-beam generating diffraction grating 11 by 100% reflectance in the direction opposite to the optical element 1.

At a position on the reflection side of the DVD outward three beams with respect to the polarizing beam splitter 12, i.e. at a position on the opposite side of the optical element 1, there is disposed a wave-selecting beam splitter 14. The DVD outward three beams reflected by the polarizing beam splitter 12 make incidence to the wave-selecting beam splitter 14.

The wave-selecting beam splitter 14 transmits through the DVD outward three beams which make incidence from the polarizing beam splitter 12 by 100% transmittance.

A collimator lens 15 is disposed at a position on the transmission side of the DVD outward three beams with respect to the wave-selecting beam splitter 14, i.e. at a position on the opposite side of the polarizing beam splitter 12. The DVD outward three beams transmitting through the wave-selecting beam splitter 14 make incidence to the collimator lens 15.

The collimator lens 15 emits the DVD outward three beams which make incidence from the wave-selecting beam splitter 14 by converting them into the parallel light.

A total reflection mirror 16 is disposed at a position on the emission side of the DVD outward three beams with respect to the collimator lens 15, i.e. at a position on the opposite side of the wave-selecting beam splitter 14.

On the total reflection mirror 16, there is formed a reflection plane having an angle of 45° with respect to the DVD outward three beams emitted from the collimator lens 15.

The total reflection mirror 16 totally reflects the DVD outward three beams which make incidence from the collimator lens 15 in a direction orthogonal to the incident direction of the DVD outward three beams.

A quarter wavelength plate 17 is disposed at a position on the total-reflection side of the DVD outward three beams with respect to the total reflection mirror 16. The DVD outward three beams which are totally reflected by the total reflection mirror 16 make incidence to the quarter wavelength plate 17.

The quarter wavelength plate 17 emits the DVD outward three beams which make incidence from the reflection mirror 16 side by converting them into the circularly polarized light.

An objective lens 18 is disposed at a position on the emission side of the DVD outward three beams with respect to the quarter wavelength plate 17, i.e. at a position on the opposite side of the total reflection mirror 16. The DVD outward three beams emitted from the quarter wavelength plate 17 make incidence to the objective lens 18.

The objective lens 18 emits the DVD outward three beams emitted from the quarter wavelength plate 17 by converting them into the converged light.

At a position on the emission side of the DVD outward three beams with respect to the objective lens 18, i.e. at a position on the opposite side of the quarter wavelength plate 17, the DVD 10 is disposed in such a manner that the recording face comes orthogonal to the main beam of the DVD outward three beams. The DVD outward three beams emitted from the objective lens 18 are concentrated onto the recording face of the DVD 10.

The DVD outward three beams which make incidence to the recording face of the DVD 10 are reflected by the recording face towards the objective lens 18 side in the inverse direction of the incident direction.

At that time, the main beam of the DVD outward three beams in the case of DVD−R or DVD+R, for example, records information on the recording face through chemical-changing of coloring matter by increasing the temperature of an organic coloring matter layer formed on the recording face of the DVD 10.

The objective lens 18 receives the three beams (referred to as DVD backward three beams hereinafter) reflected by the recording face of the DVD 10 and emits the DVD backward three beams towards the quarter wavelength plate 17 side by converting the DVD backward three beams into the parallel light.

The quarter wavelength plate 17 receives the three beams emitted from the objective lens 18 and emits the DVD backward three beams towards the total reflection mirror 16 side by converting them into the linearly polarized light whose polarization direction is rotated by 90° with respect to the DVD outward three beams.

The total reflection mirror 16 receives the DVD backward three beams emitted from the quarter wavelength plate 17, and totally reflects the DVD backward three beams towards the collimator lens 15 side at an angle of 90° The collimator lens 15 receives the DVD backward three beams which are totally reflected by the total reflection mirror 16, and emits the DVD backward three beams towards the wave-selecting beam splitter 14 side by converting them into the converged light.

The wave-selecting beam splitter 14 receives the DVD backward three beams emitted from the collimator lens 15, and transmits the DVD backward three beams towards the polarizing beam splitter 12 side by 100% transmittance.

The polarizing beam splitter 12 receives the DVD backward three beams transmitted through the wave-selecting beam splitter 14, and transmits the DVD backward three beams towards the optical element 1 side by 100% transmittance.

The optical element 1 receives the DVD backward three beams transmitted through the polarizing beam splitter 12, and generates astigmatism in the DVD backward three beams by the toric plane for focusing.

Further, the optical element 1 diffracts, by the diffraction grating 5, the DVD backward three beams which, after making incidence to the toric plane, transmit through the optical element 1 and exits from the emission-side surface 4.

By this diffraction, the light quantity of the zero-order light of the DVD backward three beams in the diffraction grating 5 is adjusted to be 58% with respect to the light quantity of the main beam of the DVD backward three beams at the time of making incidence to the optical element.

Further, the optical pickup device 7 comprises a CD light source (laser diode) 20 as a second light source for emitting second light that is coherent light with a second wavelength. This CD light source 20 emits, as linearly polarized light, the light of 780 nm wavelength as the second light for reading out the information that is recorded on the CD 21 in a direction of the wave-selecting beam splitter 14.

A CD-side three-beam generating diffraction grating 22 is disposed between the CD light source 20 and the wave-selecting beam splitter 14. The light emitted from the CD light source 20 makes incidence to the CD-side three-beam generating diffraction grating 22.

The CD-side three-beam generating diffraction grating 22, for tracking, emits the light that makes incidence from the CD light source 20 after separating it into three beams (referred to as CD outward three beams hereinafter) comprised of a single main beam and two sub-beams.

The wave-selecting beam splitter 14 receives the CD outward three beams emitted from the CD-side three-beam diffraction grating 22, and reflects the CD outward three beams towards the collimator lens 15 side by 50% reflectance.

Like the DVD outward three beams, the CD outward three beams reflected by the wave-selecting beam splitter 14 make incidence to the recording face of the CD 21 after receiving the same effects as those of the DVD outward three beams in each of the optical systems, i.e. the collimator lens 15, the total reflection mirror 16, the quarter wavelength plate 17, and the objective lens 18.

The CD outward three beams which make incidence to the recording face of the CD 21 are reflected towards the objective lens 18 side by capturing the information recorded on the recording face by the intensity of the reflected light from the recording face.

Like the DVD backward three beams, the three beams (referred to as the CD backward beams hereinafter) reflected by the recording face of the CD 21 towards the objective lens 18 side make incidence to the wave-selecting beam splitter 14 after receiving the same effects as those of the DVD backward three beams in each of the optical systems, i.e. the objective lens 18, the quarter wavelength plate 17, the total reflection mirror 16, and the collimator lens 15.

The wave-selecting beam splitter 14 transmits the incident CD backward three beams towards the polarizing beam splitter 12 side by 50% transmittance.

The polarizing beam splitter 12 receives the CD backward three beams i transmitted through the wave-selecting beam splitter 14, and transmits the CD backward three beams towards the optical element 1 side by 100% transmittance.

The optical element 1 receives the CD backward three beams emitted from the polarizing beam splitter 12, and generates astigmatism in the CD backward three beams by the toric plane. Furthermore, the optical element 1 diffracts, by the diffraction grating 5, the CD backward three beams which are transmitted through the optical element 1 and emitted from the emission-side surface 4.

By this diffraction, the light quantity of the zero-order light of the CD backward three beams in the diffraction grating 5 is adjusted to be 83% of the light quantity of the main beam (zero-order light) of the CD backward three beams at the time of making incidence to the optical element 1.

Therefore, in the embodiment, the light quantity of the zero-order light in the diffraction grating 5 in the case of the light for the CD 21, which is the light of the wavelength using the non-polarization optical system, and that in the case of the light for the DVD 10, which is the light of the wavelength using the polarization optical system, can be made identical.

As a result, the light quantities of the respective zero-order light can both be made preferable for being sensed by the photodetector 8.

Next, actions of the embodiment will be described.

First, for performing recording on the DVD 10 with this embodiment, the DVD light source 9 is radiated for emitting the light of 657 nm wavelength towards the DVD-side three-bean generating diffraction grating 11 side. Upon this, the light is converted into the DVD outward three beams by the DVD-side three-beam generating diffraction grating 11 to be emitted towards the polarizing beam splitter 12 side.

The DVD outward three beams emitted to the polarizing beam splitter 12 side make incidence to the polarizing beam splitter 12, which are reflected by the polarizing beam splitter 123 towards the wave-selecting beam splitter 14 side by 100% reflectance.

The DVD outward three beams reflected towards the wave-selecting beam splitter 14 make incidence to the wave-selecting beam splitter 14, and transmit through the wave-selecting beam splitter 14 by 100% transmittance.

The DVD outward three beams transmitted through the wave-selecting beam splitter 14 make incidence to the collimator lens 15, which are converted into the parallel light by the collimator lens 15 to be emitted towards the total reflection mirror 16 side.

The DVD outward three beams emitted to the total reflection mirror 16 side make incidence to the total reflection mirror 16, which are totally reflected by the total reflection mirror 16 towards the quarter wavelength plate 17 side.

The DVD outward three beams which are totally reflected towards the quarter wavelength plate 17 make incidence to the quarter wavelength plate 17, and are converted to the circularly polarized light by the quarter wavelength plate 17 to be emitted towards the objective lens 18 side.

The DVD outward three beams emitted towards the objective lens 18 side make incidence to the objective lens 18, which are converted into the converged light by the objective lens 18 to be emitted towards the DVD 10 side.

The DVD outward three beams emitted towards the DVD 10 side are concentrated on the recording face of the DVD 10, and reflected towards the objective lens 18 side as the DVD backward three beams after recording information on the recording face of the DVD 10.

The DVD backward three beams which are reflected towards the objective lens 18 side make incidence to the objective lens 18, and converted into the parallel light by the objective lens 18 to be emitted towards the quarter wavelength plate 17 side.

The DVD backward three beams which are emitted towards the quarter wavelength plate 17 make incidence to the quarter wavelength plate 17, and converted by the quarter wavelength plate 17 into the linearly polarized light whose polarization direction is rotated by 90° with respect to the DVD outward three beams to be emitted towards the total reflection mirror 16 side.

The DVD backward three beams which are emitted towards the total reflection mirror 16 side make incidence to the total reflection mirror 16, and totally reflected by the total reflection mirror 16 towards the collimator lens 15 side.

The DVD backward three beams which are totally reflected towards the collimator lens 15 side make incidence to the collimator lens 15, and converted into the converged light by the collimator lens 15 to be emitted towards the wave-selecting beam splitter 14.

The DVD backward three beams emitted towards the wave-selecting beam splitter 14 side make incidence to the wave-selecting beam splitter 14, and transmit through the wave-selecting beam splitter 14 by 100% transmittance.

The DVD backward three beams transmitted through the wave-selecting beam splitter 14 make incidence to the polarizing beam splitter 12, and transmit through the polarizing beam splitter 12 by 100% transmittance.

The DVD backward three beams transmitted through the polarizing beam splitter 12 generate astigmatism by making incidence to the toric plane of the optical element 1. Then, the DVD backward three beams are diffracted by the diffraction grating 5 when transmitted through the optical element 1 and emitted from the emission-side surface 4 where the diffraction grating 5 is formed.

By this diffraction, the light quantity of the zero-order light of the DVD backward three beams in the diffraction grating 5 is adjusted to be 58% with respect to the light quantity of the main beam of the DVD backward three beams at the time of making incidence to the optical element 1.

Thus, only the zero-order light of the DVD backward three beams in the diffraction grating 5 is received by the photodetecteor 8.

For performing reproduction of the CD 21 with the embodiment, the CD light source 20 is radiated for emitting the light of 780 nm wavelength towards the CD-side three-bean generating diffraction grating 22 side. Upon this, the light is converted into the CD outward three beams by the CD-side three-beam generating diffraction grating 22 to be emitted towards the wave-selecting beam splitter 14 side.

The CD outward three beams which are emitted towards the wave-selecting beam splitter 14 side make incidence to the wave-selecting beam splitter 14, and reflected by the wave-selecting beam splitter 14 towards the collimator lens 15 side by 50% reflectance.

The CD outward three beams which are reflected towards the collimator lens 15 side make incidence to the collimator lens 15, and converted by the collimator lens 15 into the parallel light to be emitted towards the total reflection mirror 16 side.

The CD outward three beams which are emitted to the total reflection mirror 16 side make incidence to the total reflection mirror 16, and totally reflected by the total reflection mirror 16 towards the quarter wavelength plate 17 side.

The CD outward three beams which are totally reflected towards the quarter wavelength plate 17 make incidence to the quarter wavelength plate 17, and converted to the circularly polarized light by the quarter wavelength plate 17 to be emitted towards the objective lens 18 side.

The CD outward three beams which are emitted towards the objective lens 18 side make incidence to the objective lens 18, and converted into the converged light by the objective lens 18 to be emitted towards the CD 21 side.

The CD outward three beams emitted towards the CD 21 side are concentrated on the recording face of the CD 21, and reflected towards the objective lens 18 side as the CD backward three beams after recording information on the recording face of the CD 21.

The CD backward three beams which are reflected towards the objective lens 18 side make incidence to the objective lens 18, and converted into the parallel light by the objective lens 18 to be emitted towards the quarter wavelength plate 17.

The CD backward three beams which are emitted towards the quarter wavelength plate 17 make incidence to the quarter wavelength plate 17, and converted by the quarter wavelength plate 17 into the linearly polarized light whose polarization direction is rotated by 90° with respect to the CD outward three beams to be emitted towards the total reflection mirror 16 side.

The CD backward three beams which are emitted towards the total reflection mirror 16 side make incidence to the total reflection mirror 16, and totally reflected by the total reflection mirror 16 towards the collimator lens 15 side.

The CD backward three beams which are totally reflected towards the collimator lens 15 side make incidence to the collimator lens 15, and converted into the converged light by the collimator lens 15 to be emitted towards the wave-selecting beam splitter 14.

The CD backward three beams emitted towards the wave-selecting beam splitter 14 side make incidence to the wave-selecting beam splitter 14, and transmit through the wave-selecting beam splitter 14 by 50% transmittance.

The CD backward three beams transmitted through the wave-selecting beam splitter 14 make incidence to the polarizing beam splitter 12, and transmit through the polarizing beam splitter 12 by 100% transmittance.

The CD backward three beams transmitted through the polarizing beam splitter 12 generate astigmatism by making incidence to the toric plane of the optical element 1. Then, the CD backward three beams are diffracted by the diffraction grating 5 when transmitted through the optical element 1 and emitted from the emission-side surface 4 where the diffraction grating 5 is formed.

By this diffraction, the light quantity of the zero-order light of the CD backward three beams in the diffraction grating 5 is adjusted to be 83% with respect to the light quantity of the main beam of the CD backward three beams at the time of making incidence to the optical element 1.

Thus, only the zero-order light of the DVD backward three beams in the diffraction grating 5 is received by the photodetecteor 8 to be used for reproduction.

At this time, the light quantity of the zero-order light of the CD backward three beams in the diffraction grating 5 is adjusted to be the same value as the light quantity of the zero-order light of the DVD backward three beams in the diffraction grating 5.

As a result, reproduction from the CD 21 and recording to DVD 10 can both be appropriately performed.

Therefore, with the embodiment, the light quantity of the zero-order light in the diffraction grating 5 can be adjusted to be the preferable light quantity for being sensed by the photodetector 8 by a simple structure through integrally forming the diffraction grating 5 with the optical element 1 having a toric plane.

As a result, an excellent optical property can be maintained without generating heat. Thus, signal processing (recording) of the light of 657 nm wavelength for the DVD 10 and signal processing (reproduction) of the light of 780 nm wavelength for the CD 21 having different wavelength from the light for the DVD can both be performed appropriately by a single photodetector 8. In addition, the cost can be cut and versatility of possible design form for the optical element 1 can be widened.

The present invention is not limited to the above-described embodiments but various modifications are possible as necessary.

For example, the present invention is not only effective when recording to the DVD 10 but also enables to achieve excellent effects when reproducing the DVD 10 like the case of recording.

Furthermore, the present invention is not only effective when performing reproduction of the CD 21 but also enables to achieve excellent effects when recording to the CD 21 like the case of reproduction.

Moreover, the present invention can be effectively applied to three or more light sources which emit coherent light having different wavelength from each other. In that case, for example, the first light source may be a DVD light source, the second light source may be a CD light source, the third light source may be a Blu-ray Disc light source, and the fourth light source may be a HDDVD light source. Alternatively, the first light source may be the DVD light source, the second light source may be the CD light source, and the third light source may be used as the light source for both the Blu-ray Disc and HDDVD.

What is claimed is:

1. An optical pickup device, comprising:
a first light source for emitting first light which is coherent light having a first wavelength;
a second light source for emitting second light which is coherent light having a second wavelength that is different from said first wavelength;
an optical information recording medium;
an objective lens for concentrating said first light and/or said second light on said optical information recording medium;
an optical element which has an astigmatism generating structure for giving astigmatism to said first light and said second light, and also has a diffraction structure for diffracting at least either said first light or said second light; and
a light receiving element for receiving light which is reflected from said optical information recording medium.

2. The optical pickup device according to claim 1, wherein both of said first light and said second light are diffracted by said diffraction structure of said optical element.

3. The optical pickup device according to claim 1, wherein light quantity of said first light that is emitted from said optical element and travels towards said light receiving element and light quantity of said second light that is emitted from said optical element and travels towards said light receiving element are adjusted to be identical.

4. An optical pickup device, comprising:
at least three light sources of a first light source for emitting first light which is coherent light having a first wavelength, a second light source for emitting second light which is coherent light having a second wavelength that is different from said first wavelength, and a third light source for emitting third light which is coherent light having a third wavelength that is different from said first wavelength and said second wavelength;
an optical information recording medium;
an objective lens for concentrating, on said optical information recording medium, at least a single set of light among said first light, said second light, and said third light;
an optical element which has an astigmatism generating structure for giving astigmatism to said first light, said second light, and said third light, and also has a diffraction structure for diffracting at least a single set of light among said first light, said second light, and said third light; and
a light receiving element for receiving light which is reflected from said optical information recording medium.

5. The optical pickup device according to any one of claims 1-4, wherein said optical element is disposed on an optical path between said objective lens and said light receiving element.

6. An optical element for receiving coherent light which is selected from at least two or more sets of coherent light having different wavelength from each other, said optical element comprising
an astigmatism generating structure for giving astigmatism to said at least two or more sets of coherent light having different wavelength from each other light, and also a diffraction structure for diffracting at least a single wavelength of light out of said at least two or more sets of coherent light having different wavelength from each other, wherein
through diffraction by said diffraction structure, light quantity on an optical axis of said at least single wavelength of light can be adjusted.

7. The optical element according to claim 6, wherein
through diffracting at least two or more wavelengths of light by said diffraction structure out of said at least two or more sets of coherent light having different wavelength from each other, light quantities on optical axis of said at least two or more wavelengths of light are adjusted.

8. The optical element according to claim 6 or claim 7, wherein said light quantities on said optical axis of said at least two or more sets of coherent light having different wavelength from each other, which are emitted from said optical element, become identical.
